(19) United States
(12) Patent Application Publication
(10) Pub. No.: US 2014/0188760 A1
(43) Pub. Date: Jul. 3, 2014

(54) METHOD AND SYSTEM FOR INTRA-PERIOD ESTIMATION OF INDEX VALUE

(71) Applicants: Christina I. Ray, New York, NY (US); Arthur T. Rodbell, McLean, VA (US)

(72) Inventors: Christina I. Ray, New York, NY (US); Arthur T. Rodbell, McLean, VA (US)

(73) Assignee: Private Capital Index, Inc. (D/B/A PCIX and PCIX, Inc.), McLean, VA (US)

(21) Appl. No.: 14/126,193

(22) PCT Filed: Jun. 18, 2012
(86) PCT No.: PCT/US2012/043035

§ 371 Date: Mar. 13, 2014

Related U.S. Application Data
(60) Provisional application No. 61/497,581, filed on Jun. 16, 2011.

(51) Int. Cl. G06Q 40/06

(52) U.S. Cl. CPC G06Q 40/06
USPC 705/36 R

(57) ABSTRACT

A method and system for intra-period estimation of index value includes the steps of providing an intra-period estimation of index value software program in a computer readable medium that is maintained in a host computer. Information is received concerning a financial investment from a data contributor, and the information includes data reported on a predetermined basis. A value is determined for each financial investment using the information. Additional information concerning the financial investment is received that includes observable data regarding each financial investment. An intra-period index is calculated using the additional information that is used in valuation of the financial activity.

### CROSS REFERENCE TO RELATED APPLICATIONS

This application claims the benefit of and priority to U.S. Provisional Application No. 61/497,581, filed Jun. 16, 2011, and PCT Application No. PCT/2012/043035, filed Jun. 18, 2012, which are hereby incorporated by reference in their entireties.

### BACKGROUND

The present disclosure relates generally to an index value for a financial product and in particular to a method and system for intra-period estimation of an index value associated with a financial product.

### DESCRIPTION OF THE RELATED ART

An index is a statistical measure of value that is frequently used with respect to a financial market to facilitate functions such a trading, benchmarking, risk management, or portfolio management of financial products. The index can relate to a certain portfolio of investment vehicles, such as securities, as in an investment index, or the like. Other examples of indexes include a commodity index, a stock index or a private investment index. For a financial product, the portfolio that makes up an investment index may consist of particular types of investments, investments in a certain industry, a group of the most important investments in a given market, or the like. The securities may be fungible, negotiable financial instruments representing financial value. Further, the securities may be broadly categorized into debt securities, such as banknotes, bonds and debentures, or the like, and equity securities, such as, common stocks, or the like. The securities may also be derivative contracts, such as forwards, futures, options, swaps, or the like. As such, an index may track factors such as the value of stocks, bonds, mutual funds, other securities, public or private investment vehicles, fund investments, as well as other indices that make up the index.

The value of certain types of indices (e.g., total return indices) increase when the aggregate value of the underlying investments increase. Conversely, the value of certain indices decrease when the aggregate value of the underlying investments decrease. The increases and decreases, that is, the value changes of such indices, are generally expressed as points and as a percentage that is tracked from a specific starting point. The particular starting point might be as recent as the previous day, previous quarter, or many years in the past. These indexes are often used as performance benchmarks against which to measure the return of investments that resemble those tracked by the index. For example, a stock market index is a method of measuring a section of the stock market. Many indices are cited by news or financial services firms and are used as benchmarks to measure the performance of portfolios, such as mutual funds. Further, indices are often used to inform quantitative risk management models that estimate the probability of gains and losses over a given horizon. And, such indices are similarly used to optimize the risk/reward profile of a given portfolio of investments.

Data used for valuation of financial products, such as an index, are typically reported at established periodic intervals of time, such as quarterly. The reporting may be public or private. The reported data can include a variety of information including net asset values, returns, and other financial performance statistics. For a financial product, such as a total return swap that may refer to a specific index, cash may flow between the parties, such as a protection buyer and protection seller, based on index value as of periodic points in time (e.g., semi-annually or quarterly).

Certain types of financial activities, such as continuous trading, financial product creation, and investment analysis, can occur at any time. As with any other index, buyers and sellers may estimate the value of the index between the official valuation reporting time periods. Most other indices that commonly serve as the reference index for financial products, however, may be valued more frequently, such as on a daily basis. These types of valuations can be used as an objective basis for the calculation and collect of variation margin for both exchange-traded products and over-the-counter (OTC) products. Such margin is collected to minimize credit risk, in the event that one side or the other is unwilling or unable to fulfill its obligation to make required contractual payments in the future. In addition, objective estimates of index values are often used to value the derivative security, estimate mark-to-market profit and loss, to measure risk, and to provide a number of risk metrics for both internal and regulatory reporting purposes.

This can be a particularly egregious problem with financial instruments or securities based on indices that are updated at relatively lower frequencies (e.g., quarterly), such as a private equity index. Private equity (PE) is an asset class consisting of equity securities in operating companies that are not publicly traded (i.e., on a stock exchange). Private equity investments are typically made by private equity firms and funds that provide working capital to a target company to fund expansion, new product development, or restructuring of the company's operations, management, or ownership. The most common private equity investments are: leveraged buyouts, venture capital, distressed investments, and real estate investments.

Because there is no publicly observable price for each private investment, each private-equity fund manager must value each investment in its portfolio, generally according to fair-value accounting standards, on a periodic basis (e.g., quarterly or annually). In the case of a private-equity fund, these values are generally reported to limited partners in the fund with a lag period of about 45 days after the end of the reporting period.

Further, private-equity investors may be reluctant to disclose the valuations they put on the companies in which they invest, in order not to lose a strategic advantage when they attempt to sell the company, either to another private investor or via a public offering. For all these reasons, information regarding the valuation of private equity investments is particularly opaque.

So, the parties to a transaction based on such an opaque index, such as a buyer and seller, are often unable to accurately estimate the value of an index at any point in time because there is a lack of transparency into estimates of value, as well as valuation methods used by the source data providers. In some instances, a variety of valuation methods may be used that are highly confidential and thus, not readily attainable. Furthermore, even if each party is able to independently estimate an accurate value of an index, by using their own proprietary models, for example, the parties may nevertheless disagree on the estimated value of the index the other has calculated. Such agreement facilitates collection of variation margin and estimation of mark-to-market values of derivative securities based on such indices, and would be facilitated by objective and credible, third-party estimates of index value. The parties to a transaction involving a private-equity index are also not privy to the information required to make informed estimates of index value. The data gathered from private equity (PE) fund managers, even at the quarterly dates, is highly proprietary, as is some of the information used to infer their internal estimates of net asset value (NAV) for each investment and of the fund. Besides NAV and return data, information such as the identity of publicly-traded peer group proxies and metrics used to estimate the value of a private investment, such as price-earnings ratios (P/E), or the like, is not open-source.

While the official index values that are publicly reported on a periodic basis offer useful information, market conditions are changing more rapidly than reported index values. Thus, there is a need in the art for a method and system for creating an interim estimate of index value for a financial related investment in-between the officially published reporting period.

### SUMMARY

Accordingly, a computer-implemented method for intra-period estimation of index value is provided. A method and system includes the steps of providing an intra-period estimation of index value software program in a computer readable medium that is maintained in a host computer. Information is received concerning a financial investment from a data contributor, and the information includes data reported on a predetermined basis. A value is determined for each financial investment using the information. Additional information concerning the financial investment is received that includes observable data regarding each financial investment. An intra-period index is calculated using the additional information that is used in valuation of the financial activity.

The method also includes the step of obtaining information, including market prices or otherwise observable valuations on publicly-traded proxies, such as individual stocks, stock indices, exchange traded funds, prices of real estate investment trusts (REITS), and the like. The method still also includes the step of estimating the value of individual investments or funds comprised of such investments, using a combination of the information received on those investments, and the prices of publicly-traded or otherwise observable valuations of proxies for those investments. The method also includes the step of determining an intra-period estimate of the index value of the investment activity. The method further includes the step of publishing the intra-period estimate, such that the published intra-period index provides a reference tool used to value financial instruments, to estimate their risk, or the like.

Advantageously, a method and system for intra-period estimation of an index value is provided in-between official public reporting of the index value. An advantage of the present disclosure is that interim estimates of index valuations can be created to facilitate trading and liquidity of financial products. Another advantage is that the intra-period estimates of index valuations are more accurate and timely than relying on a previous reporting period index. A further advantage of the present disclosure is that it can provide daily estimated market values of derivative financial products, which enable the calculation of a required margin to limit credit risk. A further advantage of the present disclosure is that it may enable compliance with regulatory requirements such as the Dodd-Frank Wall Street Reform and Consumer Protection Act (Dodd-Frank), Basel II, or the like. Still a further advantage of the present disclosure is that it provides daily time series valuations that are more suitable for quantitative analysis, including risk measurement, and portfolio optimization than reliance on any previous officially reported periodic index. A further advantage of the present disclosure is that is enables investors to make more informed investment decisions based on relative risk and reward. A further advantage of the present disclosure is that is provides a method of using non-confidential and/or highly confidential data sourced from data providers and generating index values that can be published for public use without compromising that confidential data. Still a further advantage of the present disclosure is that it provides an objective, third-party estimate of value for both parties to a financial instrument to have (irrespective of their own internal estimates) so that they can agree on the amount of variation margin required.

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is a flow chart illustrating a method of intra-period estimation of index value, according to an exemplary embodiment.

FIG. 2 is a flow chart further illustrating the method of intra-period estimation of index value by adjusting the intra-period index value for a new event.

FIG. 3 is a flow chart further illustrating the method of intra-period estimation of index value by gathering valuation information on existing investments.

FIG. 4 is a flow chart further illustrating the method of intra-period estimation of index value by gathering valuation information on new investments.

FIG. 5 is a flow chart further illustrating the method of intra-period estimation of index value by calculating a periodic index.

FIG. 6 is a flow chart further illustrating the method of intra-period estimation of index value by publishing of estimated index valuation.

FIG. 7 is a diagram of a system for generating an intra-period estimation of index valuation, according to the method of FIGS. 1-6.

### DESCRIPTION

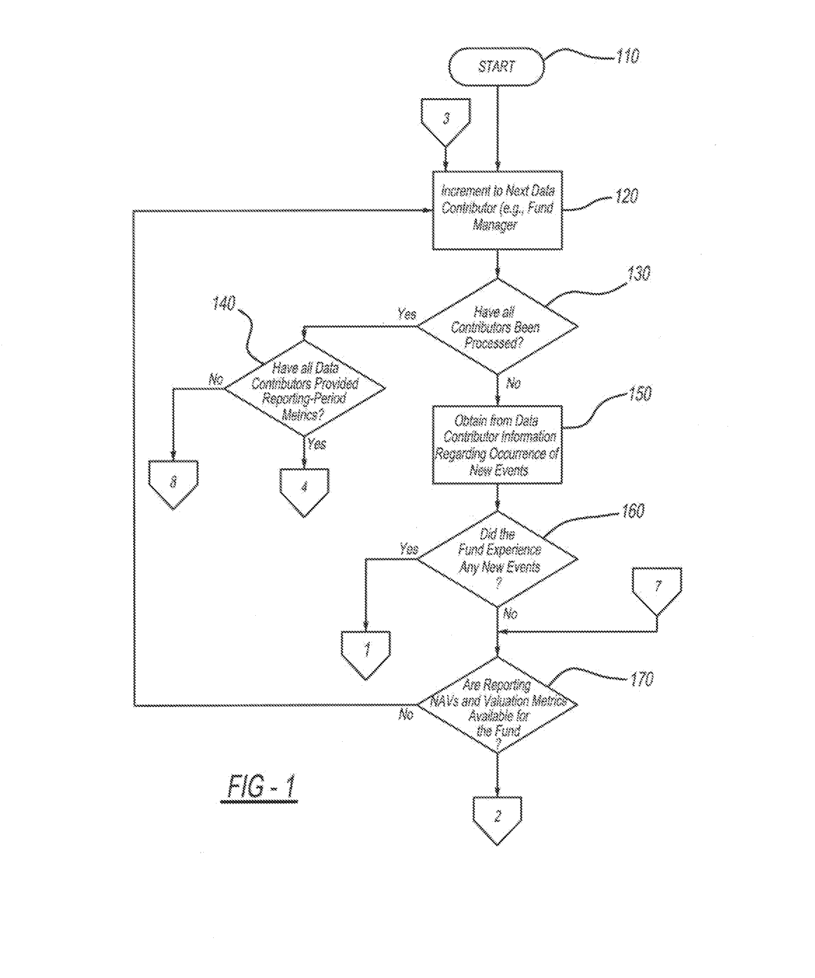

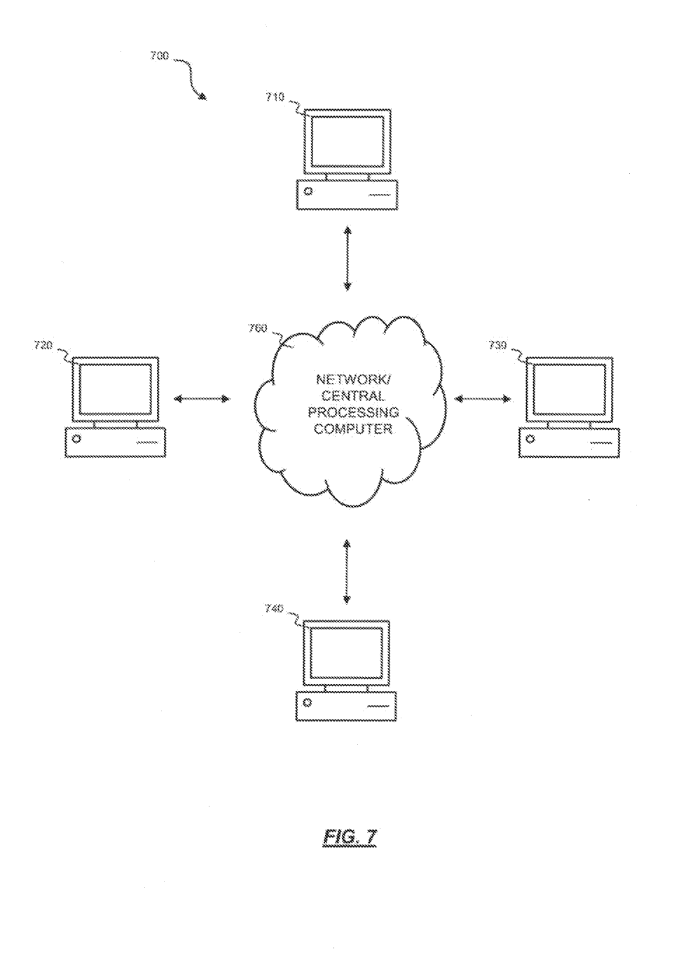

Referring to FIGS. 1-6, a method of intra-period estimation of valuation of a financial index is illustrated. The methodology is implemented using a computer based system, as shown in FIG. 7. The intra-period valuation may be used for various purposes, such as creating or facilitating the trading of financial products, margining, risk management, performance benchmarking, or other types of investment or financial related decision making. An example of the use of the index may be a reference index for a total return swap, or the like. Another example of an index may be a venture capital or private equity index as disclosed in U.S. Provisional Application Ser. No. 61/497,581 filed Jun. 16, 2011, and incorporated by reference herein in its entirety. A further example of an index may be other liquid or illiquid asset classes, such as, real estate, or the like. In still a further example, the creation of an interim estimate of index value between quarterly dates may be used for margining purposes. The method may involve a plurality of parties or entities that include, but are not limited to, individuals, buyers, sellers, clearinghouses, exchanges, banks, insurers, payers, brokers, agents, intermediaries, private equity (PE) firms, venture capital firms, index creators, risk management and portfolio advisors and analytics and data providers, performance benchmarking firms, or the like. The methodology may be utilized on a daily basis for investment level valuation.

The determination of an intra-period estimate is advantageous since it will be more accurate on a particular date than a previously reported periodic index. First, the methodology will utilize detailed and proprietary information regarding internal valuation methods for investments, such as comparable peers and earnings or sales multiples, or the like, from contributing members. Since the contributing member has provided the information, a better estimation of the value of the component investments or fund value index based on a change in price of publicly traded peers and/or surrogates for those peers (e.g., broad or industry specific index values of publicly-traded companies) is possible. Second, the output from the methodology may result in the publication of the valuations and/or other information, such as confidence intervals, or the like. This information may then be used for other purposes, such as daily revaluation of the derivatives transactions, to pass variation margin between parties, for portfolio optimization, for risk measurement and management purposes, or the like. Using, for example, fund specific rules such as algorithms based on sales, etc., or publicly-traded peer-group information and multiples obtained from each PE firm, the methodology may estimate the change in net asset value (NAV) from the previous reporting period at the investment level based on observed changes in those proxies, estimate returns, and other performance metrics. The methodology will then be able to estimate the current NAV of individual investments within each contributing fund, the NAV of the contributing fund itself, and the value of the multi-fund index. Advantageously, mid-reporting period corrections may be made as material events occur in the interim period between public reporting, such as a liquidity event, a restatement, or the like. In another example, the methodology can also provide a missing margining protocol for financial products, such as a low-frequency index, or the like, irrespective of trading venue, such as over-the-counter (OTC), exchange-traded, or the like. In a further example, the methodology can be used in investment-level index value analytics.

In this example, the frequency of the official, i.e. public, financial reporting period may be referred to as “quarterly” by way of example. However, the frequency of such public disclosure is not limited to any particular period of time, and may be any discrete reporting frequency, such as weekly, monthly, quarterly, semi-annually, and annually of the like. Likewise, in this example the frequency of intra-period reporting may be described as “daily” by way of example. Again, the frequency of such intra-period reporting may be any reporting frequency that is between the official periodic reports or disclosures, such as real time, daily, weekly, monthly or the like.

The intra-period index may have many different applications, such as to facilitate compliance with regulatory requirements. For example, Dodd-Frank may require that securities dealers in OTC derivative products (not given up to an exchange for clearing via an exchange such as the CME, as in the case of certain credit default swaps) be required to provide customers with daily estimated market values of those derivatives. The intra-period index may be utilized by a dealer to limit credit risk by providing a mechanism that enables calculation of required margin, and to comply with potential regulatory requirements, if Dodd-Frank compliance is required.

The intra-period index estimated values further represents a higher frequency time series that may be used in a quantitative analysis since the estimated values are created at a higher frequency than that of the official, reported values. For example, a securities dealer may estimate how much of a “haircut” to collect—i.e., margin it must collect to be reasonably confident that the value of the asset will not fall so far over some reasonable horizon (such as 1 day, 5 days, or the like) over which the dealer can collect margin. An analysis of the volatility of the asset's value over such short time periods is required for such estimates.

In another example, a daily time series of estimated valuations can be used for risk management purposes, portfolio optimization purposes, performance benchmarking purposes, or the like. Nearly every other asset class (such as stocks, bonds, commodities, foreign exchange, or the like) has at least daily prices. In order to properly estimate the risk of a portfolio, all pricing data must be of the same periodicity. Rather than use less correlated surrogates (such as publicly traded stocks, or the like), estimates of daily PE valuations will provide a superior input into these quantitative models. A more frequent calculation of the index, such as in a daily time series, may also enable better estimation of risk-adjusted performance—especially relative to other investments. The intra-period index will account for market high- or low-water marks that may have occurred between publicly disclosed reporting periods and avoid understating of daily price movements risk, either absolutely, or relative to another asset class.

Referring generally to FIGS. 1-6, a method of intra-period estimation of an index value is illustrated. For illustrative purposes, the financial entity is a PE fund, although as previously described the methodology may be applied to unlimited types of financial investments or entities. The methodology begins by initially gathering available data, which may be confidential, non-confidential or some combination thereof. For example, confidential find or investment level data may be gathered. The method begins at block 110 and includes the step of obtaining information from the previous reporting period. The information may be any type of relevant information to the determination of the particular index, such as reporting period NAVs, mid-asset value, peer sets, sector concentration or the like. The methodology also collects information regarding events that have occurred during the current interim period as well as intra-period information regarding valuation methodologies and requisite metrics. Information about some of these events may be entirely public, entirely private, or a combination of the two. The data may be acquired from various from data contributors, such as from a fund manager (i.e. a PE fund General Partner). The information may include various occurrences such as those having a material effect on the value of an individual investment, a fund, an index, or the like. An example of the types of information includes fund information, fund investments, and fund value.

The method proceeds to block 120 and includes the step of incrementing to the next data contributor. The data gathering steps may be repeated until all information has been acquired. In the PE example, the data may be acquired for each PE fund on a periodic basis (e.g., quarterly).

The method then proceeds to block 130 and includes the step of determining whether all data contributors have been processed. This insures that the set of information is complete to enhance the accuracy of the analysis.

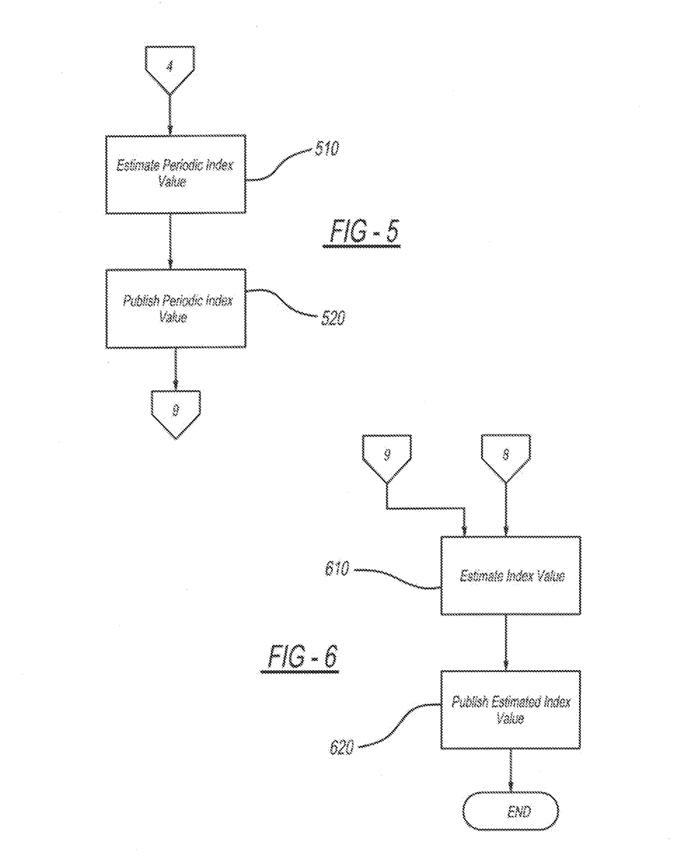

If all of the data contributors have been processed, the method proceeds to block 140 wherein it is determined if all data contributors have provided reporting-period metrics, such as NAV and valuation period metrics. If all of the data contributors have provided reporting period metrics the method proceeds to block 510 of FIG. 5 and continues to calculate the periodic index. If all of the data contributors have not provided reporting-metrics, the method advances to block 610 of FIG. 6 and estimates the intra-period index, as described in further detail below.

Returning to block 130, if all of the data contributors have not been processed, the method proceeds to block 150 wherein information regarding occurrences of new events is obtained from the data contributors. Examples of material events include liquidity events, new investments, reinstatements, or the events that may affect the estimated investment value. The data contributor may be specifically queried regarding the needed information.

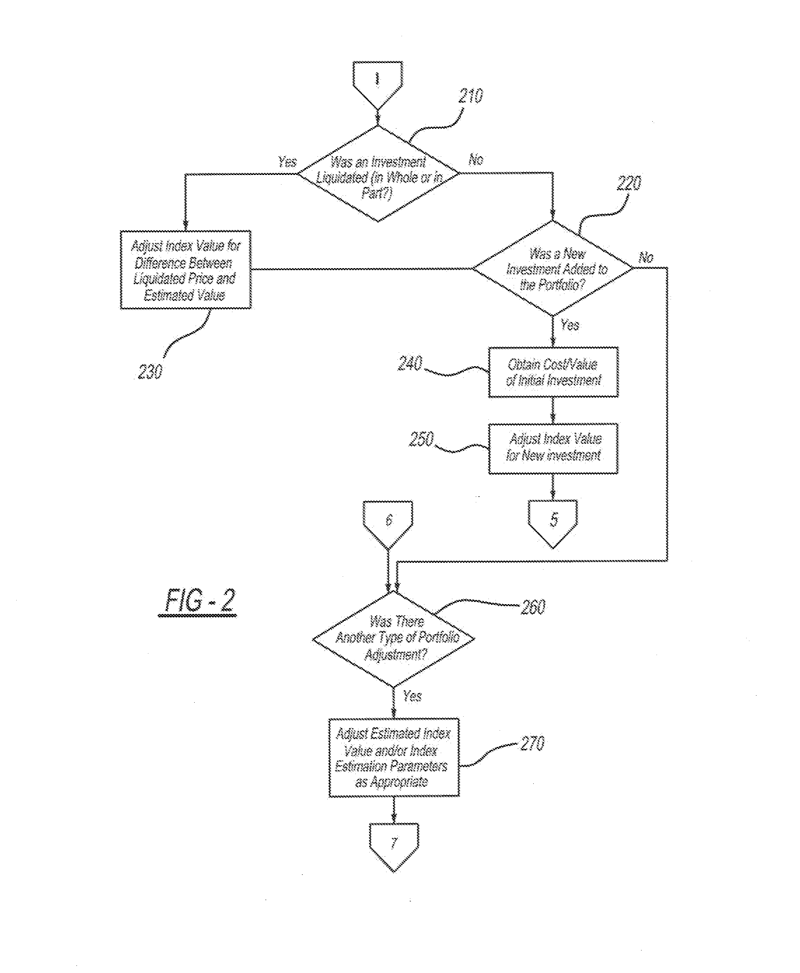

Next, the method proceeds to block 160 and includes the step of determining whether the fund of this example experienced any new events. The event could be any type of event that could impact the value, such as going public, liquidating an asset or the like. If the fund experienced any new events, the method proceeds to block 210 of FIG. 2 and adjusts the intra-period index value as described in further detail below.

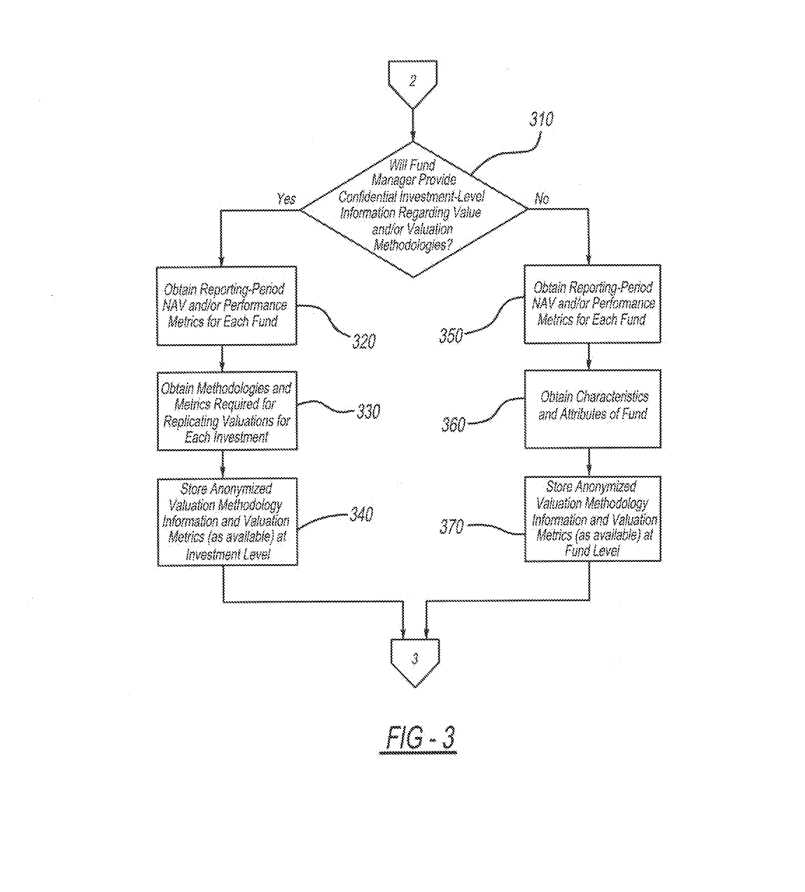

Returning to block 160, if the fund did not experience any new events, the method proceeds to block 170. Here, it is determined whether reporting period NAVs and valuation metrics are available for the financial entity, or fund. For example, it is determined whether values and metric are publicly or otherwise available for the reporting period, i.e. quarterly report. If reporting period NAVs and valuation metrics are not available for this fund the method returns to block 120 to query the next data contributor. If reporting period NAVs and valuation metrics are available for the fund the method proceeds to block 310 of FIG. 3 which is described in further detail below.

Referring now to FIG. 2, the method adjusts the intra-period index value for new events and requisite information for subsequent estimates is obtained. This sub-process commences from block 160 of FIG. 1 if a fund experienced any new events.

The method begins at block 210 and includes the step of determining whether an investment was liquidated in whole or in part. If the investment was not liquidated in whole or in part the method proceeds to block 220 and includes the step of determining whether a new investment was added to the portfolio.

Returning to block 210, if the investment was liquidated in whole or in part the method proceeds to block 230 wherein the index value is adjusted for differences between the liquidated price and the estimated value. For example, if an asset was liquidated, the weighting of that investment is adjusted to reflect the conversion of the asset to cash. The method then returns to block 220 and continues until all new investments have been accounted for.

Once all the index value has been adjusted to include new investments, the method proceeds to block 240 and includes the step of obtaining the cost/value of the initial investment. For example, it is assumed that on the day of the investment, the value is equal to the price paid, although adjustments for different valuation techniques may be applied.

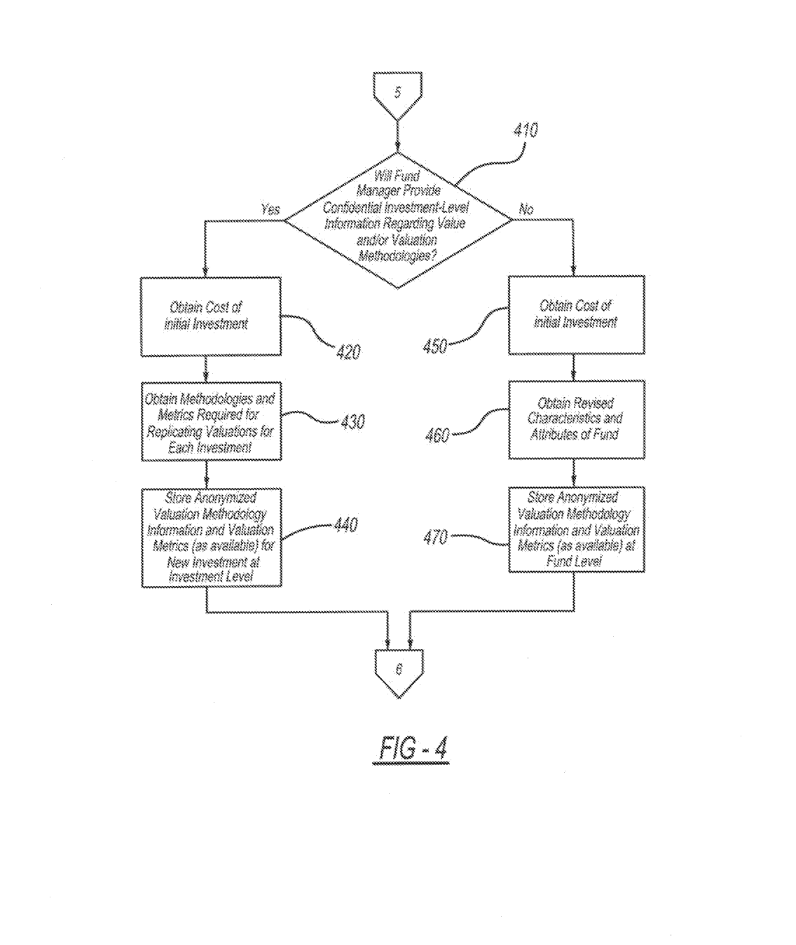

Next, the method proceeds to block 250 and includes the step of adjusting the index value based on the new investment. For example, each investment may be assigned a dynamic weighting. It should be appreciated that the weighting may change during the valuation process. The weighting may be based on factors such as individual investment type, concentrations by sector, fund objectives, performance of asset class, or index value. Historical patterns of behavior may be considered, or statistical techniques may be utilized in determining the weighting. Once the index value has been adjusted, the method proceeds to block 410 of FIG. 4 which is described in further detail below.

Returning to block 220, if a new investment was not added to the portfolio, the method proceeds to block 260 and includes the step of determining whether there was another type of portfolio adjustment that may have an influence on the index value. For example, it is determined whether a reinstatement of fund value or other extraordinary and significant financial event has occurred.

If there is not another type of portfolio adjustment needed the method returns to block 170 of FIG. 1. If there is another type of portfolio adjustment needed the method proceeds to block 270 which includes the step of adjusting the estimated index value and/or index estimation parameters as appropriate. The estimated index value is adjusted as previously described with respect to block 250. The methodology then returns to block 170 of FIG. 1 and continues.

Referring now to FIG. 3, the method determines what information is available either publicly or confidentially and gathers valuation information on existing investments. For this example, the method obtains confidential data regarding the specific methodologies and metrics utilized by each fund manager to estimate a fair value for each investment and performance metrics for each fund. The information may be stored in anonymized fashion in a confidential database for subsequent use in estimation of intra-period investment and/or fund values. This process is repeated for each reporting period as defined by the fund manager.

The method begins at block 310 and includes the step of determining whether the fund manager will provide confidential investment-level information regarding value and/or valuation methodologies for a specific fund.

If the fund manager will provide confidential investment-level information regarding value and/or methodologies used, the method proceeds to block 320 and includes the step of obtaining information such as reporting-period NAV and/or performance metrics for each fund. Other types of information may similarly be relevant. Next, the method proceeds to block 330 and includes the step of obtaining methodologies and metrics required for replicating valuations for each investment. For example, a list of publicly traded proxy companies (i.e. peer set), P/E multiples, sales rations, and/or other methodologies used to estimate the value of an illiquid security from public and/or private financial information and market prices. Next, the method proceeds to block 340 and includes the step of storing anonymized valuation methodology information and valuation metrics, as available, at an investment level. Once complete, the method returns to block 120 of FIG. 1.

Returning to block 310, if the fund manager will not provide confidential investment-level information, such as information regarding value and/or methodologies used by the fund, the method proceeds to block 350 and includes the step of obtaining reporting-period NAV and/or performance metrics for each fund. Next, the method proceeds to block 360 and includes the step of obtaining characteristics and attributes of the fund. The information about the aggregate characteristics and attributes of composite investments that comprise the fund may include but are not limited to, types of investments, industry sector/subsector concentration, size, location, age, or the like. Next, the method proceeds to block 370 and includes the step of storing anonymized valuation methodology information and valuation metrics, as available, at a fund level. Once completed, the method returns to block 120 of FIG. 1.

Referring now to FIG. 4, the method gathers valuation information on new investments. For example, the method obtains confidential data regarding the methodology and metrics utilized by each fund manager to estimate fair value for each investment and performance metrics for each fund. The information may be stored in an anonymized fashion in a confidential database for subsequent use in estimation of intra-period investment and/or fund values. This process occurs when a new investment is made.

The method begins at block 410 when a new investment is made and includes the step of determining whether a fund manager will provide confidential investment-level information regarding value and/or valuation methodologies.

If the fund manager will provide confidential investment-level information regarding value and/or valuation methodologies the method proceeds to block 420 and includes the step of obtaining the cost of the initial investment. Next, the method proceeds to block 430 and includes the step of obtaining methodologies and metrics required for replicating valuations for the new investment. For example, the methodologies or metrics may include a list of publicly traded proxy companies, P/E multiples, sales rations, and/or other methodologies used to estimate the value of an illiquid security from public and/or private financial information and/or market prices or the like. Next, the method proceeds to block 440 and includes the step of storing anonymized valuation methodology information and/or valuation metrics, as available, for the new investment at an investment level. Once complete, the method returns to block 260 of FIG. 2.

Returning to block 410, if the fund manager will not provide confidential investment-level information regarding value and/or valuation methodologies the method proceeds to block 450 and includes the step of obtaining the cost of the initial investment. Next, the method proceeds to block 460 and includes the step of obtaining revised characteristics and attributes of the fund. For example, information about the aggregate characteristics and attributes of composite investments that comprise the fund which may include, but is not limited to, types of investments, industry sector/subsector concentration, size, location, age, or the like. Next, the method proceeds to block 470 and includes the step of storing the anonymized valuation methodology information and/or valuation metrics, as available, at a fund level. Once complete, the method returns to block 260 of FIG. 2 and continues.

Referring now to FIG. 5, the method calculates the periodic index calculation. For example, the method calculates and publishes official reporting period index values when all index members reported their individual contributions. The reporting period index is the official value of the index, which is calculated solely from originally-sourced fund values and is therefore suitable as the reference index for financial products.

The method begins at block 510 which includes the step of estimating the periodic index value. The periodic index value is created from information collected. For example, the index may be statistically adjusted based on information from the end of the reporting period, weights determined by the attributes of the fund and its investments (e.g., industry sector and geographical concentrations) and other factual and historical information. The method then proceeds to block 520 and includes the step of publishing the periodic index value. Once complete, the method proceeds to block 610 of FIG. 6, which is described in further detail below.

Referring now to FIG. 6, the method determines the intra-period index value. It is contemplated that the method calculates and publishes the estimated index value at a higher frequency (e.g., daily, weekly, monthly) than the publically reporting period calculations. The intra-period calculations are only estimates based on public and private sources of data. Further, even on dates when reporting period index values are made available, (i.e. in confidence to limited in private-equity funds) partners estimated values may also be published due to the inherent lag period associated with periodic reporting of fund NAVs.

The method begins at block 610 and includes the step of estimating the index value. The may be done by using a variety of information alone or in combination, such as confidential NAV data, together with confidential and open-source financial information, market prices or the like. The method then proceeds to block 620 and includes the step of publishing the estimated index value.

It is noted that the methodology described is merely an exemplary embodiment and that the methodology may be modified by rearranging the sequence of the method steps, adding additional method steps, removing method steps, changing the particular parties performing the steps, or the like. For example, the methodology may also include the step of making mid-reporting period corrections as material events (such as a liquidity event, a restatement, or the like) occur. For example, the methodology may include the step of gathering such alternative data as is used to estimate reporting-period NAVs and returns, or to use surrogate estimation methods in cases where fund managers are unwilling or unable to provide highly granular detail regarding their internal valuation methodologies. Similarly, it may include such steps as appropriate for valuing other asset types, such as venture capital or real estate, or non-domestic assets (such as including exchange rate conversions). Estimations and other calculations derived in the method may be generated using a variety of techniques, such as statistical models, mathematical algorithms, financial methodologies, or the like.

The methodology may also include the step of using the valuations for various purposes, such as margining, risk management, performance benchmarking, simulation of historical time series for use in quantitative analysis, providing investment valuation services or the like. In one example, the valuations are used to pass variation margin between parties, such as a buyer and seller, or the like.

Most existing financial-market indices use publicly-available data with discrete, definite values. For example, the value of the S&P 500, i.e. stock prices, can be reproduced using publicly-available data. By contrast, the daily estimate of fund values or the investments that comprise the fund cannot be directly observed in the marketplace. Such funds may be private, or they be provided by the fund managers at a lower frequency, such as quarterly. Higher-frequency estimates (e.g., daily) must instead be estimated from metrics supplied by the fund manager that allow the methodology to estimate fund values. For example, some portfolio managers may be willing to provide confidential information about the individual company investments within a fund, their values, or their “peer sets”. A peer set refers to the names of publicly-traded companies that are expected to be suitable proxies for the private company. Alternatively, some portfolio managers may not be willing to provide such investment-level information, and will instead be willing to characterize the fund with respect to certain risk factors. For example, they might indicate the percentages of the fund invested in certain industry sectors (e.g., health care, energy) and by geographical region (e.g., US, Europe, China). However, in either of these cases, the methodology may use proprietary, quantitative analytics to estimate the fair market value of the fund. This may be accomplished either directly, or as a portfolio of component investments as if evaluated by the fund managers daily. The method uses techniques that mimic to some degree the valuation methodologies used by the contributing fund managers. These methodologies may also include historical experience and statistical behavior as an input to the models.

Component portfolio values may not be directly observed in a marketplace or obtained confidentially from an index member portfolio manager. Instead, such values must be estimated using multiple quantitative models populated by varying types of financial data. The selected methodology should minor the various internal methodologies used by the component funds. The index weights assigned to the funds in the index may be dynamically weighted to meet objectives. An example of an objective is to mirror the behavior of a given asset class (e.g., private equity) with respect to a variety of risk factors, such as to industry sectors, geographical concentrations, or the like. Another example of an objective is to ensure that proprietary source information, including but not limited to fund or investment level NAVs, remains confidential and protected. Confidentially may be provided by using predetermined weighting values. The technique use for estimation may be an amalgamation of various estimation methodologies, which use the type and granularity that contributing managers are comfortable providing. The index may be calculated from private data, using quantitative models that use as input diverse characterizations of portfolio composition, as specified by each fund manager. These models identify a set of publicly-traded proxies for such investments.

Referring now to FIG. 7, a system 700 for estimating an intra-period index value is provided. The intra-period index value may be used in creating and facilitating the trading and management of listed or OTC financial products. In this example, the system 700 includes a host computer 760, such as a server, having a processor and a memory associated with the processor. The intra-period index software program is maintained in the memory associated with the host computer 760. The system 700 may also include a plurality of computers associated with various information providers. The information provider may be a fund manager, a pubic data reporting service, or the like. The information provider computer may likewise have a processor and a memory associated with the processor, such as the first party system 710, a second party system 720, a third party system 730, a fourth party system 740 shown in FIG. 7.

The host computer 760 can provide control over the system and can perform any of the various processing services and/or functions described herein. The host computer 760 may be a single computer or system of computers and/or may include any number or plurality of computers or computer systems which are utilized in conjunction with one another. The host computer 760 can provide services for any of the other computers and/or computer systems described herein as being associated with any of the parties or entities involved, such as, individuals, buyers, sellers, clearinghouses, exchanges, banks, insurers, payers, brokers, agents, intermediaries, private equity firms, venture capital firms, or the like. For example, secure servers may be resident at each data provider's site, sending only encrypted data to the servers of the party analyzing and publishing data.

The host computer and information provider computer can communicate via a communication network. The communications network may be a local area network, intranet, internet or the like. The communications signal may be transmitted using available technology, such as wired, wireless or the like.

Either the host computer or remote computes may include a user input device, for entering data and/or commands into any of the devices, which includes any one or more of a keyboard, a scanner, printer, a user pointing device, such as, for example, a mouse, a touch pad, and/or an audio input device and/or a video input device, flash memory drive, and/or any device, electronic and/or otherwise which can be utilized for inputting and/or entering data and/or information, which input device(s) can also be connected to the CPU. Any of the devices can also include a display device for displaying data and/or information to a user or operator.

Any of the devices can also include a transmitter(s), for transmitting signals and/or data and/or information (e.g., modem, etc.) to any one or more of the devices which may be utilized in conjunction with the present innovation. Any of the devices can also includes a receiver, for receiving signals and/or data and/or information from any one or more of the devices which may be utilized in conjunction with the present innovation.

Any of the devices can include a database(s) which contains data and/or information pertaining to the parties and/or entities who or which are serviced by the present innovation and/or who or which utilize the present innovation. The database(s) can contain any and/or all of the information needed and/or required in order to perform any and/or all of the functions, services and/or operations described herein as being performed by the system and/or any of the devices. In this regard the database can contain data and/or information regarding and any other data and/or information regarding the individuals, buyers, sellers, clearinghouses, exchanges, banks, insurers, payers, brokers, agents, intermediaries, firms, financial products, exchange rates, currencies, securities, stocks, futures, commodities, or the like which would be needed and/or desired in order to perform any and/or all of the functions, services and/or operations described herein.

The system and method of the present innovation can be utilized unlimited ways in order to provide a vast array of financial and financial-related services for any one or more of the various parties or entities described herein. While the embodiments may be described with regards to utilization by a particular party or entity, it is important to note that any of the parties and/or entities described herein may utilize the present innovation in the same, similar and/or analogous manner.

Many modifications and variations of the present disclosure are possible in light of the above teachings. Therefore, within the scope of the appended claim, the present disclosure may be practiced other than as specifically described.

What is claimed is:

1. A method for intra-period estimation of an index value for a financial activity, the method comprising the steps of:
providing an intra-period estimation of index value software program in a computer readable medium that is maintained in a host computer;
receiving information concerning a financial investment from a data contributor, wherein the information includes data reported on a predetermined basis;
determining a value for each financial investment using the information;
receiving additional information concerning the financial investment, wherein the additional information includes observable data regarding each financial investment;
estimating an intra-period index using the additional information, wherein the intra-period index is used in valuation of the financial activity.

2. The method of claim 1, further including the step of publishing the estimated intra-period index value.

3. The method of claim 1 further including the step of calculating a composite value using each investment valuation within an index to derive an official reporting-period index value based on the information from the data contributor.

4. The method of claim 1, wherein information from the data contributor includes investment information from a group selected from private equity, venture capital, or real estate.

5. The method of claim 1, wherein the additional data includes data selected from a group including market prices, observable valuations of publicly-traded proxies stocks, stock indices, exchange traded funds or prices of real estate investment trusts (REITS).

6. The method of claim 1, wherein the intra-period index is computed on a daily basis.

7. The method of claim 1 wherein the step of a receiving data from the data contributor further includes the steps of:
determining if the data contributor has provided data for a predetermined reporting period;
determining if there has been a new event having an influence on the intra-period index and adjusting the intra-period index value based on the new event.

8. The method of claim 1 further comprising the step of obtaining confidential information regarding an existing investment and adjusting the index value using the confidential information.

9. The method of claim 1 further comprising the step of determining if the data contributor will provide confidential information regarding an existing investment and obtaining the reporting period net asset value (NAV) and performance metrics related to the existing investment, and methodology and metrics used to replicate the value of the existing investment if the data contributor will provide the confidential information and obtaining a reporting period NAV or performance metric of the existing investment and obtaining characteristics and attributes of the fund to replicate the value of the existing investment.

10. The method of claim 1, further comprising the step of:
determining if the data contributor will provide confidential information regarding a new investment and obtaining the initial cost of the new investment, and methodology and metrics used to replicate the value of new investment if the data contributor will provide the confidential information and obtaining a cost of the initial investment and imputing characteristics and attributes of the investment to replicate the value of the new investment.

11. The method of claim 1 further comprising the step of confirming the official reporting period index value.

12. The method of claim 11 further comprising the step of publishing the confirmed reporting period index value.

13. The method of claim 1 wherein the intra-period index is determined by applying a weighting to the value of each investment.

14. A method of intra-period estimation of an index value for a financial activity, the method comprising the steps of;
providing an intra-period estimation of index value software program in a computer readable medium that is maintained in a host computer;
obtaining a reporting period Net Asset Value for a financial activity;
obtaining intra-period event information for the financial activity;
obtaining valuation methodologies and metrics for the financial activity;
adjusting the estimated intra-period index value for a new event;
obtaining confidential information regarding the methodology and metrics used to estimate value of an existing investment associated with the financial activity;
obtaining confidential information regarding the methodology and metrics used to estimate value of a new investment associated with the financial activity;
using the reporting period Net Asset Value, intra-period event information, valuation methodologies and metrics, confidential information regarding existing investments and confidential information regarding new investments to determine an intra-period index value for use in valuation of the financial activity.

15. The method of claim 14 wherein the intra-period index is determined by applying a weighting to a value for each investment.

16. The method of claim 14, further including the step of publishing the estimated intra-period index value.

17. The method of claim 14 further including the step of calculating a composite value using each investment valuation within an index to derive an official reporting-period index value based on the information from each data contributor.

18. The method of claim 14, wherein the intra-period information is from a data contributor selected from a group including private equity, venture capital, or real estate.

19. The method of claim 14, wherein the intra-period information includes data selected from a group including market prices, observable valuations of publicly-traded proxies stocks, stock indices, exchange traded funds or prices of real estate investment trusts (REITS).

20. The method of claim 14, wherein the intra-period index is computed on a daily basis.
